(19) United States
(12) Patent Application Publication
(10) Pub. No.: US 2025/0246705 A1
(43) Pub. Date: Jul. 31, 2025

(54) POWER STORAGE DEVICE

(71) Applicant: Toyota Jidosha Kabushiki Kaisha, Toyota-shi (JP)

(72) Inventors: Shintaro UTSUMI, Susono-shi (JP); Takeru Hara, Toyota-shi (JP); Masataka Ogushi, Nisshin-shi (JP); Yuji Nishi, Nagoya-shi (JP); Naofumi Nomura, Nagakute-shi (JP); Nariaki Miki, Okazaki-shi (JP); Kenta Kimura, Toyota-shi (JP)

(73) Assignee: Toyota Jidosha Kabushiki Kaisha, Toyota-shi (JP)

(21) Appl. No.: 18/975,210

(22) Filed: Dec. 10, 2024

(30) Foreign Application Priority Data
Jan. 30, 2024 (JP) 2024-011848

(51) Int. Cl. H01M 10/613; H01M 10/653; H01M 10/6556; H01M 50/548

(52) U.S. Cl. CPC H01M 10/613; H01M 10/653; H01M 10/6556; H01M 50/548

(57) ABSTRACT

A power storage device includes: a power storage module that includes a power storage cell and an electrode terminal disposed on the power storage cell; and a cooler that cools the power storage cell. The electrode terminal is disposed on an end surface of the power storage cell in a Y direction intersecting a Z direction. The cooler includes an upper portion disposed above the power storage module. Further, the cooler includes a protruding portion protruding from the upper portion in the Y direction, in a direction in which the protruding portion is more spaced apart from the power storage cell than the electrode terminal.

### CROSS REFERENCE TO RELATED APPLICATIONS

This nonprovisional application is based on Japanese Patent Application No. 2024-011848 filed on Jan. 30, 2024 with the Japan Patent Office, the entire contents of which are hereby incorporated by reference.

### BACKGROUND OF THE DISCLOSURE

### Field of the Disclosure

The present disclosure relates to a power storage device.

### Description of the Background Art

Japanese National Patent Publication No. 2023-529400 discloses a battery pack including a plurality of unit cells, a tray, a temperature equalizing plate, and cooling pipes. The plurality of unit cells are accommodated in an accommodation space of the tray. The temperature equalizing plate covers an upper opening of the accommodation space of the tray. The cooling pipes are disposed on an outer surface (a surface opposite to the accommodation space) of the temperature equalizing plate.

### SUMMARY OF THE DISCLOSURE

Although not explicitly described in Japanese National Patent Publication No. 2023-529400, electrode terminals may be disposed on the unit cells. Here, since the temperature equalizing plate (a cooler) is located above the unit cells, when dew condensation water adhering to the temperature equalizing plate drips downward, the dew condensation water may adhere to an electrode terminal.

The present disclosure has been made to solve the aforementioned problem, and an object thereof is to provide a power storage device that can suppress dew condensation water generated on a cooler from dripping and adhering to an electrode terminal.

A power storage device according to one aspect of the present disclosure includes: a power storage module that includes a power storage cell and an electrode terminal disposed on the power storage cell; and a cooler that cools the power storage cell. The electrode terminal is disposed on an end surface of the power storage cell in a first direction intersecting a vertical direction. The cooler includes a first portion disposed above the power storage module, and a second portion protruding from the first portion in the first direction, in a spaced-apart direction in which the second portion is more spaced apart from the power storage cell than the electrode terminal.

In the power storage device according to the one aspect of the present disclosure, as described above, the second portion protrudes from the first portion in the first direction, in the spaced-apart direction in which the second portion is more spaced apart from the power storage cell than the electrode terminal. Thereby, an end portion of the second portion in the first direction is disposed at a position spaced apart from the electrode terminal in the spaced-apart direction. Thereby, even when dew condensation water drips downward from the end portion of the second portion in the first direction, it is possible to suppress the dew condensation water from adhering to the electrode terminal.

In the power storage device according to the one aspect, preferably, the cooler includes a downward extending portion. The downward extending portion extends downward from the second portion. With such a configuration, the downward extending portion can suppress the dew condensation water dripping from the end portion of the second portion in the first direction from adhering to the electrode terminal.

In this case, preferably, the downward extending portion overlaps the electrode terminal when viewed from the spaced-apart direction. With such a configuration, the downward extending portion can more reliably suppress the dew condensation water dripping from the second portion from adhering to the electrode terminal, when compared with a case where the downward extending portion does not overlap the electrode terminal.

In the power storage device in which the downward extending portion overlaps the electrode terminal, preferably, the downward extending portion is located lower than a lower end of the electrode terminal. With such a configuration, the downward extending portion can further reliably suppress the dew condensation water dripping from the second portion from adhering to the electrode terminal, when compared with a case where the downward extending portion is not located lower than the lower end of the electrode terminal.

The power storage device in which the cooler includes the downward extending portion preferably includes a heat conductive material that is filled between the downward extending portion and the electrode terminal and is in contact with each of the downward extending portion and the electrode terminal. With such a configuration, the electrode terminal can be cooled effectively by the downward extending portion through the heat conductive material.

In this case, the downward extending portion includes a coolant flow path through which a coolant flows. With such a configuration, the electrode terminal can be cooled more effectively by the coolant flowing through the coolant flow path, through the heat conductive material.

In the power storage device including the heat conductive material, preferably, the heat conductive material is filled into a region located between the end surface of the power storage cell and the downward extending portion and above the electrode terminal. With such a configuration, the heat conductive material filled into the region can suppress dew condensation water generated above the electrode terminal (dew condensation water adhering to an inner surface of the cooler) from adhering to the electrode terminal.

In this case, preferably, the power storage module includes a first power storage cell and a second power storage cell. The first power storage cell and the second power storage cell are arranged in a second direction intersecting each of the first direction and the vertical direction. A gap is provided between the first power storage cell and the second power storage cell. A void portion in which the heat conductive material is not disposed is formed between the gap and the downward extending portion. With such a configuration, dew condensation water can be generated actively in the void portion which does not overlap the electrode terminal in the vertical direction. As a result, it is possible to consume water vapor in the air (change water vapor into dew condensation water) while suppressing adhesion of dew condensation water to the electrode terminal. By consuming the water vapor in the air by the void portion, it is possible to suppress generation of dew condensation water in portions other than the void portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device according to one embodiment.

FIG. 2 is a perspective view showing a configuration of a power storage cell according to one embodiment.

FIG. 3 is a plan view of a cooler according to one embodiment as viewed from a Z1 side.

FIG. 4 is a cross sectional view taken along a line IV-IV in FIG. 3.

FIG. 5 is a partial enlarged view of the vicinity of an electrode terminal on a Y1 side in FIG. 4.

FIG. 6 is a cross sectional view taken along a line VI-VI in FIG. 4.

FIG. 7 is a cross sectional view taken along a line VII-VII in FIG. 3.

FIG. 8 is a cross sectional view of a power storage module and a cooler according to a first modification of one embodiment.

FIG. 9 is a cross sectional view of a power storage module and a cooler according to a second modification of one embodiment.

FIG. 10 is a cross sectional view of a power storage module and a cooler according to a third modification of one embodiment.

FIG. 11 is a cross sectional view of power storage modules and coolers according to a fourth modification of one embodiment.

FIG. 12 is a cross sectional view of power storage modules and a cooler according to a fifth modification of one embodiment.

FIG. 13 is a cross sectional view of power storage modules and a cooler according to a sixth modification of one embodiment.

### DESCRIPTION OF THE PREFERRED EMBODIMENTS

Hereinafter, an embodiment of the present disclosure will be described in detail with reference to the drawings. In the drawings, the same or corresponding parts will be designated by the same reference numerals, and the description thereof will not be repeated.

It should be noted that an X direction, a Y direction, and a Z direction in the present specification are directions orthogonal to each other. Each of the X direction and the Y direction is a horizontal direction. The Z direction is a vertical direction. Of the Z direction, a Z1 direction and a Z2 direction are an upward direction and a downward direction, respectively. It should be noted that the X direction and the Y direction are examples of the “second direction” and the “first direction”, respectively, in the present disclosure. The Z direction is an example of the “vertical direction” in the present disclosure.

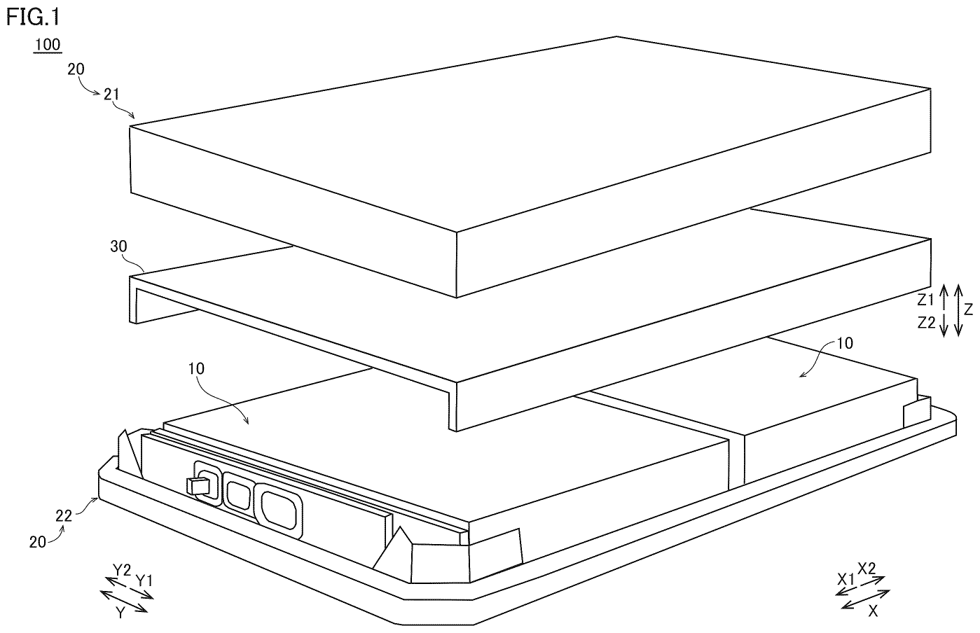

FIG. 1 is a perspective view showing a configuration of a power storage device 100 according to the present embodiment. Power storage device 100 is a device for storing electric power for driving an electrically powered vehicle (not shown), for example. The X direction and the Y direction are a front/rear direction and a right/left direction, respectively, of the electrically powered vehicle. The X direction and the Y direction may be the right/left direction and the front/rear direction, respectively, of the electrically powered vehicle. Further, power storage device 100 may be provided in an electric device other than the electrically powered vehicle (for example, a stationary power storage device).

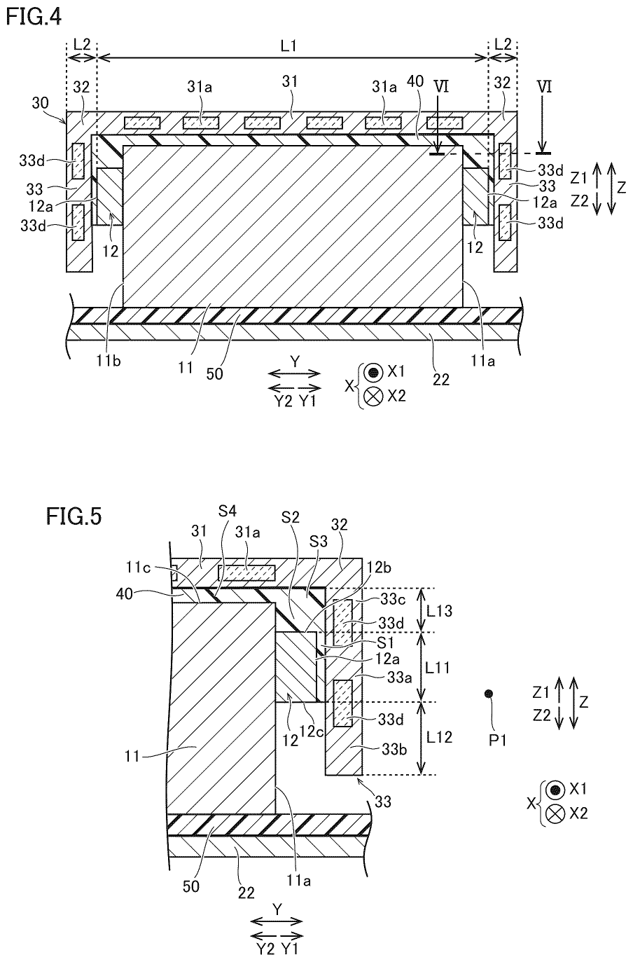

Power storage device 100 includes a plurality of power storage modules 10 (two in the present embodiment), a case 20, a cooler 30, and a heat conductive material 40 (see FIG. 4). In FIG. 1, heat conductive material 40 is omitted for simplicity. It should be noted that heat conductive material 40 has insulation properties. Further, the number of power storage modules 10 may be one, or three or more.

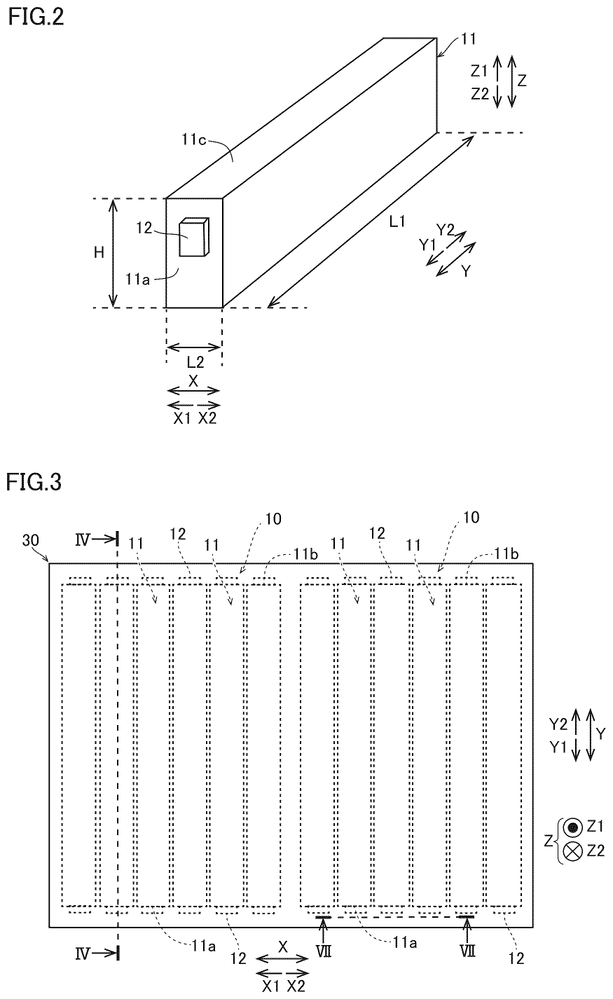

Each of the plurality of power storage modules 10 includes a power storage cell 11 (see FIG. 2) and an electrode terminal 12 (see FIG. 2). Each of the plurality of power storage modules 10 includes a plurality of power storage cells 11. Electrode terminal 12 is disposed on each of the plurality of power storage cells 11.

FIG. 2 is a perspective view showing a structure of power storage cell 11. Each of the plurality of power storage cells 11 is formed to extend in the Y direction. Specifically, each of the plurality of power storage cells 11 has a prismatic shape formed to extend in the Y direction. Further, the plurality of power storage cells 11 in each power storage module 10 are arranged (stacked) in the X direction (see FIG. 3). Power storage cell 11 has a length La in the Y direction. Power storage cell 11 has a length Lb in the X direction. Length La is larger than length Lb. That is, power storage cell 11 has a longitudinal direction in the Y direction. Further, power storage cell 11 has a height H in the Z direction. Height H is smaller than length La. Further, height H is larger than length Lb. It should be noted that the plurality of power storage cells 11 have the same structure.

Electrode terminal 12 is disposed on an end surface 11a of power storage cell 11 on a Y1 side. Further, electrode terminal 12 is also disposed on an end surface 11b (see FIG. 3) of power storage cell 11 on a Y2 side. Electrode terminals 12 of the plurality of power storage cells 11 are connected to each other by a bus bar (not shown), and thereby power storage cells 11 are electrically connected to each other. It should be noted that each of end surface 11a and end surface 11b extends to be orthogonal to the Y direction.

Referring to FIG. 1 again, case 20 accommodates the plurality of power storage modules 10 and cooler 30. Case 20 includes an upper case 21 and a lower case 22. The plurality of power storage modules 10 and cooler 30 are accommodated in a space formed by assembling upper case 21 and lower case 22. It should be noted that the configuration of case 20 is not limited to the example shown in FIG. 1. For example, case 20 may not include upper case 21.

Cooler 30 cools each of the plurality of power storage modules 10. Cooler 30 cools each of the plurality of power storage cells 11 and a plurality of electrode terminals 12 in each power storage module 10.

FIG. 3 is a plan view of cooler 30 as viewed from a Z1 side. As shown in FIG. 3, each of the plurality of power storage modules 10 is covered from the Z1 side by cooler 30 (an upper portion 31 described later).

FIG. 4 is a cross sectional view of power storage device 100 taken along the Y direction (a cross sectional view taken along a line IV-IV in FIG. 3). It should be noted that cross sections of power storage device 100 along the Y direction have the same shape, even though they are taken at different positions in the Y direction.

As shown in FIG. 4, power storage device 100 includes an adhesive layer 50. Adhesive layer 50 adheres lower case 22 and (a bottom surface of) power storage cell 11. Power storage cell 11 is fixed to lower case 22 by adhesive layer 50.

Cooler 30 includes upper portion 31, a pair of protruding portions 32, and a pair of downward extending portions 33. It should be noted that upper portion 31 and protruding portion 32 are examples of the “first portion” and the “second portion”, respectively, in the present disclosure.

Upper portion 31 is a portion disposed on the Z1 side of power storage module 10. Electrode terminal 12 includes an end portion 12a provided opposite to power storage cell 11. Upper portion 31 is a portion of cooler 30 extending from a Y-direction position of end portion 12a of electrode terminal 12 disposed on end surface 11a to a Y-direction position of end portion 12a of electrode terminal 12 disposed on end surface 11b. Upper portion 31 has a length L1 in the Y direction. It should be noted that upper portion 31 extends in a planar shape to be orthogonal to the Z direction.

Upper portion 31 includes a coolant flow path 31a through which a coolant flows. Coolant flow path 31a extends in the X direction. That is, the coolant in coolant flow path 31a flows in the X direction. Coolant flow path 31a may extend in the Y direction. The coolant flowing through coolant flow path 31a cools power storage cell 11. It should be noted that electrode terminal 12 may be cooled by the coolant flowing through coolant flow path 31a.

Here, in a conventional power storage device, when dew condensation water adhering to a cooler drips downward, the dew condensation water may adhere to an electrode terminal.

Accordingly, in the present embodiment, each of the pair of protruding portions 32 protrudes from upper portion 31 in the Y direction, in a spaced-apart direction in which protruding portion 32 is more spaced apart from the power storage cell than electrode terminal 12. In other words, each of the pair of protruding portions 32 protrudes more than electrode terminal 12. Thereby, dew condensation water generated on upper portion 31 drips downward at a position more spaced apart than electrode terminal 12 in the spaced-apart direction.

Specifically, one of the pair of protruding portions 32 extends from an end portion of upper portion 31 on the Y1 side toward the Y1 side. The other of the pair of protruding portions 32 extends from an end portion of upper portion 31 on the Y2 side toward the Y2 side. Each of the pair of protruding portions 32 is formed integrally with upper portion 31.

Each of the pair of protruding portions 32 has a length L2 in the Y direction. Length L2 is smaller than length L1 of upper portion 31. It should be noted that each of the pair of protruding portions 32 also extends in the X direction to correspond to the plurality of electrode terminals 12 arranged in the X direction. That is, each of the pair of protruding portions 32 extends in a planar shape to be orthogonal to the Z direction.

Further, each of the pair of downward extending portions 33 extends downward (toward a Z2 side) from protruding portion 32. Specifically, one of the pair of downward extending portions 33 extends downward from protruding portion 32 on the Y1 side. The other of the pair of downward extending portions 33 extends downward from protruding portion 32 on the Y2 side. Each of the pair of downward extending portions 33 extends in the Z direction. Further, each of the pair of downward extending portions 33 also extends in the X direction to correspond to the plurality of electrode terminals 12 arranged in the X direction. That is, each of the pair of downward extending portions 33 extends in a planar shape to be orthogonal to the Y direction. It should be noted that each of the pair of downward extending portions 33 extends downward from an end portion of protruding portion 32 opposite to upper portion 31.

The one and the other of the pair of downward extending portions 33 are formed integrally with the one and the other of the pair of protruding portions 32, respectively. That is, cooler 30 is formed of a single plate member. Cooler 30 is bent to have a U shape that is convex on the Z1 side when viewed from the X1 side, for example.

It should be noted that the configuration of power storage module 10 on the Y1 side is the same as the configuration of power storage module 10 on the Y2 side. Therefore, only the configuration of power storage module 10 on the Y1 side will be described below as a representative example.

FIG. 5 is a partial enlarged view of the vicinity of electrode terminal 12 on the Y1 side in FIG. 4. Downward extending portion 33 has a portion 33a, a portion 33b, and a portion 33c. It should be noted that the configuration on the Y1 side shown in FIG. 5 is the same as the configuration on the Y2 side.

Downward extending portion 33 overlaps electrode terminal 12 when viewed from the spaced-apart direction (the Y1 side in FIG. 5). Specifically, portion 33a is a portion that overlaps electrode terminal 12 when downward extending portion 33 and electrode terminal 12 are viewed from a position P1 spaced apart from downward extending portion 33 and electrode terminal 12 in the spaced-apart direction (the Y1 side in FIG. 5). In detail, portion 33a extends from a Z-direction position of an upper end 12b of electrode terminal 12 to a Z-direction position of a lower end 12c of electrode terminal 12 on the Z2 side. Portion 33a has a length L11 in the Z direction.

Downward extending portion 33 is located lower (on the Z2 side) than lower end 12c of electrode terminal 12. Specifically, portion 33b is a portion located lower than lower end 12c of electrode terminal 12. That is, portion 33b is disposed below portion 33a and is connected to portion 33a. Portion 33b has a length L12 in the Z direction. Length L12 is larger than length L11 of portion 33a. Length L12 may be equal to or smaller than length L11.

Portion 33c is a portion located higher (on the Z1 side) than upper end 12b of electrode terminal 12. Portion 33c connects portion 33a and protruding portion 32. Portion 33c has a length L13 in the Z direction. Length L13 is smaller than each of length L11 and length L12. Length L13 may be equal to or larger than at least one of length L11 and length L12.

Downward extending portion 33 includes a coolant flow path 33d through which the coolant flows. Coolant flow path 33d is formed to extend in the X direction. Coolant flow path 33d may be formed to extend in the Z direction. Further, coolant flow path 33d may communicate with coolant flow path 31a, or may be separated (independent) from coolant flow path 31a.

Heat conductive material 40 is filled between cooler 30 and power storage cell 11 (electrode terminal 12). Specifically, heat conductive material 40 is filled between downward extending portion 33 and electrode terminal 12. In detail, heat conductive material 40 is filled into a region S1 (gap) located between portion 33a and electrode terminal 12. Thereby, heat conductive material 40 in region S1 is in contact with each of downward extending portion 33 (portion 33a) and electrode terminal 12.

Heat conductive material 40 is filled into a region S2 located between end surface 11a of power storage cell 11 and downward extending portion 33 and above electrode terminal 12. That is, heat conductive material 40 is filled into a gap between end surface 11a and portion 33c. Thereby, heat conductive material 40 in region S2 is in contact with each of downward extending portion 33 (portion 33c) and power storage cell 11.

Heat conductive material 40 is filled into a region S3 located between region S2 and cooler 30 (upper portion 31, protruding portion 32). Region S3 is provided on the Z1 side of region S2 and overlaps region S2 in the Z direction.

Heat conductive material 40 is filled into a region S4 located between an upper end surface 11c of power storage cell 11 and cooler 30 (upper portion 31). Region S4 is a region sandwiched in the Y direction between region S3 on the Y1 side and region S3 on the Y2 side.

As described above, heat conductive material 40 is filled into regions S1 to S4. In other words, regions S1 to S4 are filled up with heat conductive material 40. It should be noted that heat conductive material 40 is filled (diffused) to the Z-direction position corresponding to lower end 12c of electrode terminal 12.

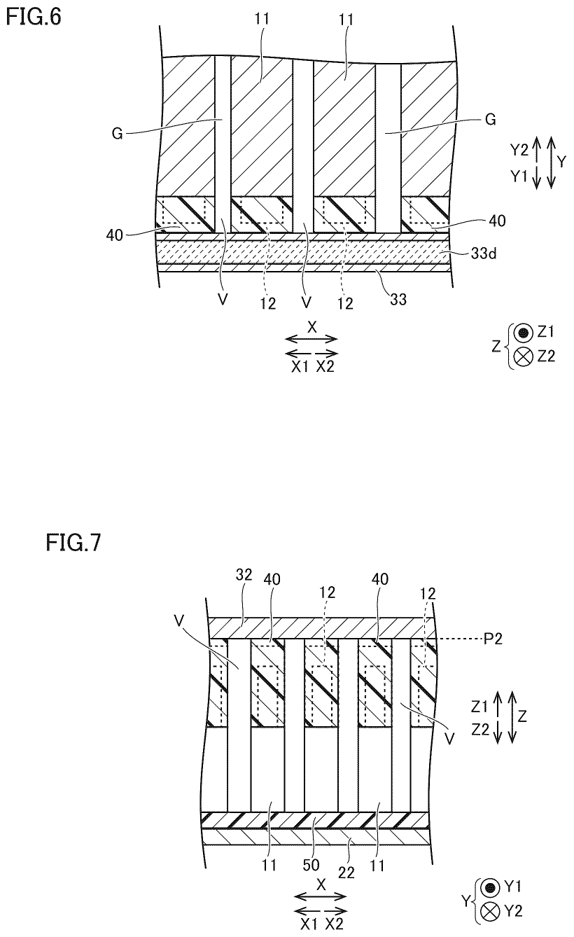

FIG. 6 is a cross sectional view taken along a line VI-VI in FIG. 4. As shown in FIG. 6, a gap G is provided between the plurality of power storage cells 11. It should be noted that power storage cells 11 arranged in the X direction shown in FIG. 6 are examples of the “first power storage cell” and the “second power storage cell” in the present disclosure.

In the present embodiment, a void portion V in which heat conductive material 40 is not disposed is formed between gap G and downward extending portion 33. Void portion V extends in the Z direction, at least from a position corresponding to lower end 12c of electrode terminal 12 to a position corresponding to upper end surface 11c of power storage cell 11. Specifically, as shown in FIG. 7, void portion V extends to a Z-direction position P2 corresponding to a contact surface between upper portion 31 (protruding portion 32) and heat conductive material 40.

As described above, in the present embodiment, cooler 30 includes protruding portion 32 protruding from upper portion 31 in the Y direction, in the direction in which protruding portion 32 is more spaced apart from power storage cell 11 than electrode terminal 12. Thereby, dew condensation water generated by upper portion 31 can drip downward at a position more spaced apart from power storage cell 11 than electrode terminal 12. As a result, it is possible to suppress the dew condensation water from dripping onto electrode terminal 12.

Further, in the present embodiment, cooler 30 includes downward extending portion 33 extending downward from protruding portion 32. Thereby, downward extending portion 33 can shield a region in which electrode terminal 12 is disposed, from a region through which the dew condensation water dripping from protruding portion 32 passes. As a result, it is possible to suppress the dew condensation water from adhering to electrode terminal 12.

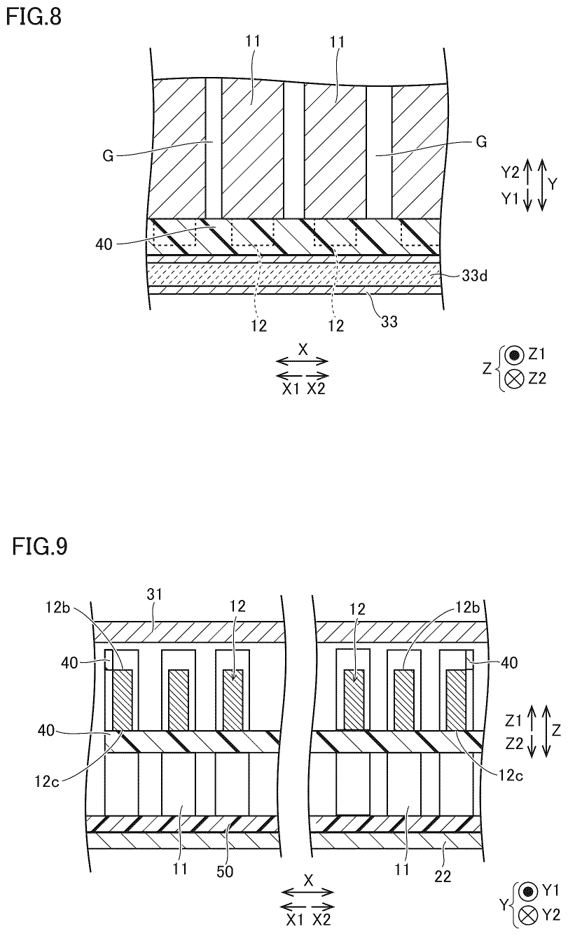

Although the above embodiment has described an example in which void portion V is formed between downward extending portion 33 and gap G between power storage cells 11, the present disclosure is not limited thereto. Heat conductive material 40 may also be filled between gap G and downward extending portion 33 as shown in FIG. 8. It should be noted that FIG. 8 is a cross sectional view at a position corresponding to FIG. 6.

Although the above embodiment has described an example in which heat conductive material 40 is not provided below electrode terminal 12, the present disclosure is not limited thereto. Heat conductive material 40 may be provided below electrode terminal 12. In the example shown in FIG. 9, heat conductive material 40 extending in the X direction is disposed to cover lower end 12c of each electrode terminal 12 from below. Thereby, it is possible to suppress the dew condensation water from adhering to electrode terminal 12 from below. It should be noted that heat conductive material 40 is not filled into regions S2 and S3 (see FIG. 5).

In the example shown in FIG. 9, heat conductive material 40 is not disposed on upper end 12b of each electrode terminal 12. On the other hand, heat conductive material 40 is disposed in a region that is higher than upper end 12b and is closer to the X1 side than electrode terminal 12, of power storage cell 11 closest to the X1 side among the plurality of power storage cells 11 arranged in the X direction. Further, heat conductive material 40 is disposed in a region that is higher than upper end 12b and is closer to the X2 side than electrode terminal 12, of power storage cell 11 closest to the X2 side among the plurality of power storage cells 11 arranged in the X direction. Thereby, it is possible to suppress the dew condensation water from entering a region in which the plurality of electrode terminals 12 are arranged in the X direction, from the side.

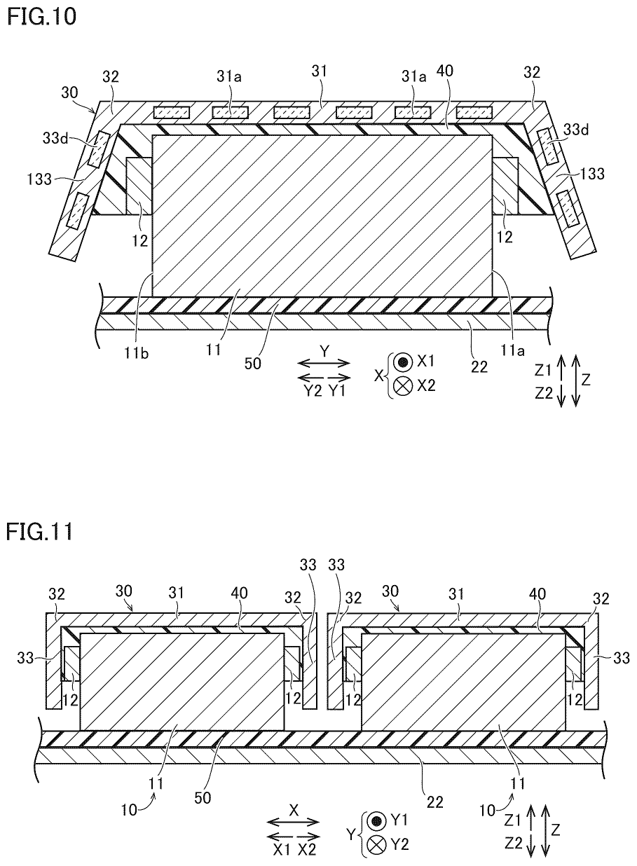

Although the above embodiment has described an example in which downward extending portion 33 is formed to extend in the Z direction, the present disclosure is not limited thereto. The downward extending portion may not extend in the Z direction. In the example shown in FIG. 10, a downward extending portion 133 extends to be inclined relative to the Z direction. Specifically, downward extending portion 133 is inclined to be spaced apart from electrode terminal 12 in the Y direction as it extends from protruding portion 32 toward the Z2 side.

It should be noted that, although the example shown in FIG. 10 has described an example in which protruding portion 32 extends in the Y direction, the present disclosure is not limited thereto. The protruding portion may be inclined as with downward extending portion 133.

Although the above embodiment has described an example in which each of the plurality of power storage cells 11 in power storage module 10 extends in the Y direction (has the longitudinal direction in the Y direction), the present disclosure is not limited thereto. Each power storage cell 11 may extend in the X direction (have the longitudinal direction in the X direction).

For example, in the example shown in FIG. 11, cooler 30 disposed over power storage module 10 on the X1 side and cooler 30 disposed over power storage module 10 on the X2 side are separately provided.

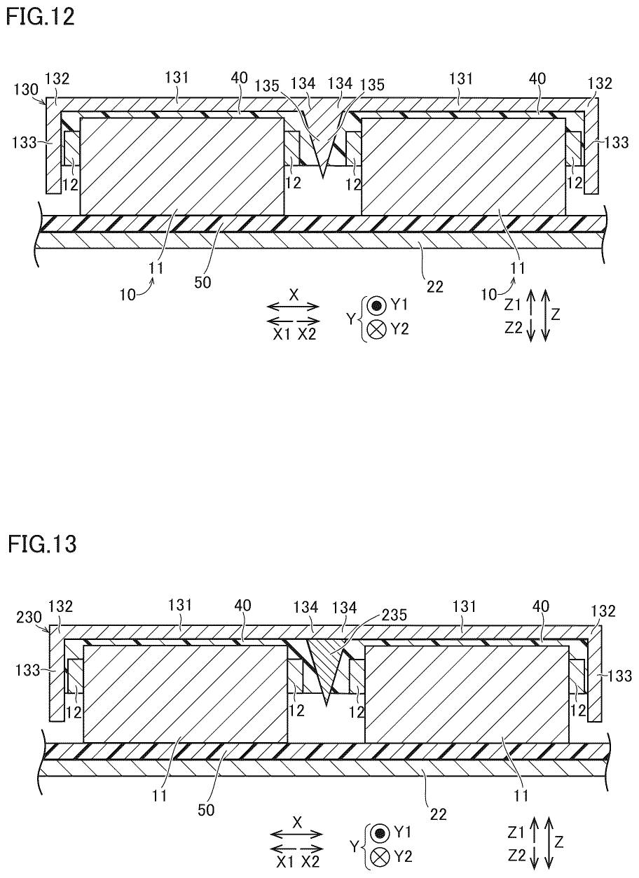

In the example shown in FIG. 12, one cooler 130 is disposed to straddle power storage module 10 on the X1 side and power storage module 10 on the X2 side. Cooler 130 includes upper portions 131, protruding portions 132, downward extending portions 133, protruding portions 134, and downward extending portions 135. Upper portion 131 is disposed above each of two power storage modules 10. Protruding portion 132 protrudes more toward the X1 side than electrode terminal 12 on the X1 side of power storage cell 11 on the X1 side. Further, protruding portion 132 protrudes more toward the X2 side than electrode terminal 12 on the X2 side of power storage cell 11 on the X2 side. Downward extending portion 133 extends downward from each of these two protruding portions 132. It should be noted that upper portion 131 is an example of the “first portion” in the present disclosure. Further, each of protruding portion 132 and protruding portion 134 is an example of the “second portion” in the present disclosure.

Protruding portion 134 protrudes more toward the X2 side than electrode terminal 12 on the X2 side of power storage cell 11 on the X1 side. Further, protruding portion 134 protrudes more toward the X1 side than electrode terminal 12 on the X1 side of power storage cell 11 on the X2 side. These two protruding portions 134 are connected to each other. Downward extending portion 135 extends downward from each of these two protruding portions 134. These two downward extending portions 135 are connected to each other. Specifically, these two downward extending portions 135 form a projection portion that is convex downward. It should be noted that, in FIG. 12, the cross section of the projection portion taken along an XZ plane has a triangular shape. The cross section of the projection portion taken along the XZ plane may have a rectangular shape, for example. It should be noted that, although the illustration is simplified in FIG. 12, each of upper portion 131, downward extending portion 133, and downward extending portion 135 may be provided with a coolant flow path through which the coolant flows.

In the example shown in FIG. 13, a cooler 230 includes a downward extending portion 235 having the same shape as that of the projection portion that is convex downward in FIG. 12. Downward extending portion 235 is disposed to straddle two protruding portions 134. Downward extending portion 235 is fixed to each protruding portion 134 with an adhesive, a fastening member, or the like. Downward extending portion 235 may be provided with a coolant flow path through which the coolant flows. Further, downward extending portion 235 may be a heat dispersion plate or the like not provided with a coolant flow path.

Although the above embodiment has described an example in which cooler 30 is provided with downward extending portion 33, the present disclosure is not limited thereto. The cooler may not be provided with a downward extending portion.

Although the above embodiment has described an example in which downward extending portion 33 overlaps electrode terminal 12 when viewed from position P1 (see FIG. 5), the present disclosure is not limited thereto. Downward extending portion 33 may not overlap electrode terminal 12 when viewed from position P1. That is, the downward extending portion may not be provided with portion 33a and portion 33b. Further, when viewed from position P1, downward extending portion 33 may overlap an upper portion of electrode terminal 12, and downward extending portion 33 may not overlap a lower portion of electrode terminal 12.

Although the above embodiment has described an example in which downward extending portion 33 is provided with coolant flow path 33d, the present disclosure is not limited thereto. The downward extending portion may not be provided with coolant flow path 33d. The downward extending portion may be a heat dispersion plate not provided with a coolant flow path. In this case, heat conductive material 40 may not be filled between the downward extending portion and electrode terminal 12 (power storage cell 11).

Although the above embodiment has described an example in which upper portion 31 is provided with coolant flow path 31a, the present disclosure is not limited thereto. The upper portion may not be provided with a coolant flow path. The upper portion may be a heat dispersion plate not provided with a coolant flow path. In this case, heat conductive material 40 may not be filled between the upper portion and power storage cell 11.

Although the above embodiment has described an example in which the plurality of power storage cells 11 in power storage module 10 are arranged in the X direction, the present disclosure is not limited thereto. The number of power storage cells included in power storage module 10 may be one.

Although the above embodiment has described an example in which downward extending portion 33 is formed integrally with protruding portion 32, the present disclosure is not limited thereto. The downward extending portion may be provided separately from protruding portion 32. For example, the downward extending portion may be fixed to protruding portion 32 with an adhesive, a fastening member, or the like.

Although the above embodiment has described an example in which downward extending portion 33 extends downward from the end portion of protruding portion 32 in the Y direction, the present disclosure is not limited thereto. Downward extending portion 33 may extend downward from a portion closer to upper portion 31 than the end portion of protruding portion 32 in the Y direction.

Although the above embodiment has described an example in which electrode terminal 12 is disposed on each of end surface 11a and end surface 11b of power storage cell 11, the present disclosure is not limited thereto. Electrode terminal 12 may be disposed on only one of end surface 11a and end surface 11b.

Although the above embodiment has described an example in which the X direction, the Y direction, and the Z direction are orthogonal to each other, the present disclosure is not limited thereto. At least two of the X direction, the Y direction, and the Z direction may intersect each other without being orthogonal to each other.

It should be noted that the configurations of the embodiment and the various modifications described above may be combined with each other.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage device comprising:
a power storage module that includes a power storage cell and an electrode terminal disposed on the power storage cell; and
a cooler that cools the power storage cell, wherein
the electrode terminal is disposed on an end surface of the power storage cell in a first direction intersecting a vertical direction, and
the cooler includes
a first portion disposed above the power storage module, and
a second portion protruding from the first portion in the first direction, in a spaced-apart direction in which the second portion is more spaced apart from the power storage cell than the electrode terminal.

2. The power storage device according to claim 1, wherein
the cooler includes a downward extending portion, and
the downward extending portion extends downward from the second portion.

3. The power storage device according to claim 2, wherein the downward extending portion overlaps the electrode terminal when viewed from the spaced-apart direction.

4. The power storage device according to claim 3, wherein the downward extending portion is located lower than a lower end of the electrode terminal.

5. The power storage device according to claim 2, further comprising a heat conductive material that is filled between the downward extending portion and the electrode terminal and is in contact with each of the downward extending portion and the electrode terminal.

6. The power storage device according to claim 5, wherein the downward extending portion includes a coolant flow path through which a coolant flows.

7. The power storage device according to claim 5, wherein the heat conductive material is filled into a region located between the end surface of the power storage cell and the downward extending portion and above the electrode terminal.

8. The power storage device according to claim 7, wherein
the power storage module includes a first power storage cell and a second power storage cell,
the first power storage cell and the second power storage cell are arranged in a second direction intersecting each of the first direction and the vertical direction,
a gap is provided between the first power storage cell and the second power storage cell, and
a void portion in which the heat conductive material is not disposed is formed between the gap and the downward extending portion.
